(19) United States
(12) Patent Application Publication
(10) Pub. No.: US 2026/0281795 A1
(43) Pub. Date: Sep. 17, 2026

(54) METHOD AND APPARATUS OF SUPPORTING BURST ARRIVAL TIME (BAT) REPORTING

(71) Applicant: LENOVO (BEIJING) LIMITED, Beijing (CN)

(72) Inventors: Mingzeng DAI, Shanghai (CN); Lianhai WU, Beijing (CN); Xiaoying XU, Beijing (CN); Jing Han, Beijing (CN)

(21) Appl. No.: 19/471,101

(22) PCT Filed: Jul. 17, 2023
(86) PCT No.: PCT/CN2023/107717

§ 371 Date: Sep. 30, 2025

(51) Int. Cl. H04W 28/02; H04L 5/00

(52) U.S. Cl. CPC H04W 28/0268; H04L 5/0048; H04W 28/0273

(57) ABSTRACT

Various aspects of the present disclosure relate to a method and apparatus of supporting burst arrival time (BAT) reporting. An exemplary UE includes: at least one memory; and at least one processor coupled with the at least one memory and configured to cause the UE to: receive, a request of BAT of a QoS flow, from a network side; determine a BAT of the QoS flow, wherein the BAT of the QoS flow is a time value relative to a boundary of a system frame number (SFN); and transmit the determined BAT of the QoS flow to the network side.

### TECHNICAL FIELD

The present disclosure relates to wireless communications, and more specifically to technique of supporting burst arrival time (BAT) reporting.

### BACKGROUND

A wireless communication system may include one or multiple network communication devices, such as base stations, which may support wireless communications for one or multiple user communication devices, which may be otherwise known as user equipment (UE), or other suitable terminology. The wireless communication system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communication system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the methods and apparatuses described herein may include a UE for wireless communication, wherein the UE includes: at least one memory; and at least one processor coupled with the at least one memory and configured to cause the UE to: receive, a request of BAT of a QoS flow, from a network side; determine a BAT of the QoS flow, wherein the BAT of the QoS flow is a time value relative to a boundary of a system frame number (SFN); and transmit the determined BAT of the QoS flow to the network side.

In some implementations of the methods and apparatuses described herein, the at least one processor is configured to cause the UE to: receive, the request of BAT of the QoS flow, from a source RAN node; determine the BAT of the QoS flow used in the source RAN node; and transmit the determined BAT of the QoS flow to the source RAN node.

In some implementations of the methods and apparatuses described herein, the at least one processor is configured to cause the UE to: receive, the request of BAT of the QoS flow, from a master node (MN); determine the BAT of the QoS flow used in the MN; and transmit the determined BAT of the QoS flow to the MN.

In some implementations of the methods and apparatuses described herein, the determined BAT of the QoS flow is transmitted to the network side in UE assistance information message.

In some implementations of the methods and apparatuses described herein, the at least one processor is configured to cause the UE to: receive, the request of BAT of the QoS flow, from an MN; determine the BAT of the QoS flow according to a type of a data radio bearer (DRB) that the QoS flow belongs to; and transmit the determined BAT of the QoS flow to the MN.

In some cases of the methods and apparatuses described herein, the at least one processor is configured to cause the UE to: receive information indicating an updated type of the DRB that the QoS flow belongs to; and determine the BAT of the QoS flow according to the updated type of the DRB that the QoS flow belongs to.

In some cases of the methods and apparatuses described herein, the at least one processor is configured to cause the UE to: determine the BAT of the QoS flow by using SFN time of a primary cell (PCell) in the case that the DRB is served by master cell group (MCG) only; or determine the BAT of the QoS flow by using SFN time of a primary secondary cell (PSCell) in the case that the DRB is served by secondary cell group (SCG) only; or determine a first BAT of the QoS flow by using the SFN time of the PCell and a second BAT of the QoS flow by using the SFN time of the PSCell in the case that the DRB is served by both the MCG and SCG; or determine the BAT of the QoS flow by using SFN time of a special cell (SPCell) of a configured primary path in the case that the DRB is served by uplink split bearer.

In some implementations of the methods and apparatuses described herein, the at least one processor is configured to cause the UE to: receive, the request of BAT of the QoS flow, from an MN; determine the BAT of the QoS flow according to a cell indicated by the MN for calculating BAT; and transmit the determined BAT of the QoS flow to the MN.

In some cases of the methods and apparatuses described herein, the at least one processor is configured to cause the UE to: determine the BAT of the QoS flow by using SFN time of a PCell in the case that only the PCell or MCG is indicated; or determine the BAT of the QoS flow by using SFN time of a PSCell in the case that only the PSCell or SCG is indicated; or determine a first BAT of the QoS flow by using the SFN time of the PCell and a second BAT of the QoS flow by using the SFN time of the PSCell in the case that both PCell and PSCell are indicated or both the MCG and SCG are indicated.

In some cases of the methods and apparatuses described herein, the at least one processor is configured to cause the UE to: transmit the first BAT and the second BAT to the MN with information indicating which BAT is for MCG and which BAT is for SCG, in the case that the both the first BAT and second BAT are determined.

In some implementations of the methods and apparatuses described herein, the at least one processor is configured to cause the UE to: receive, the request of BAT of the QoS flow in MCG configuration, from an MN; determine the BAT of the QoS flow by using SFN time of a PCell and transmit the determined BAT of the QoS flow to the MN.

In some implementations of the methods and apparatuses described herein, the at least one processor is configured to cause the UE to: receive, the request of BAT of the QoS flow in SCG configuration, from an MN; determine the BAT of the QoS flow by using SFN time of a PSCell; and transmit the determined BAT of the QoS flow to the MN.

In some implementations of the methods and apparatuses described herein, the at least one processor is configured to cause the UE to: receive, the request of BAT of the QoS flow, from an MN or an SN, wherein the BAT of the QoS flow is configured to be reported by a signalling radio bearer (SRB) 3; determine the BAT of the QoS flow by using SFN time of a PSCell of SCG; and transmit the determined BATs of the QoS flow to the SN.

In some implementations of the methods and apparatuses described herein, the at least one processor is configured to cause the UE to: receive, the request of BAT of the QoS flow, from an MN or an SN, wherein the BAT of the QoS flow is configured by an SRB 3; determine the BAT of the QoS flow by using SFN time of a PSCell of SCG; and transmit the determined BATs of the QoS flow to the SN by SRB3.

In some implementations of the methods and apparatuses described herein, the boundary of an SFN is a boundary of a reference SFN, or a boundary of an SFN in which the BAT is transmitted.

In some implementations of the methods and apparatuses described herein, the reference SFN and the boundary of the reference SFN are configured or is default, and/or the boundary of the SFN in which the BAT is transmitted is a starting point of a starting subframe of the SFN.

Some implementations of the methods and apparatuses described herein may further include a processor for wireless communication, wherein the processor includes: at least one controller coupled with at least one memory and configured to cause the processor to: receive, a request of BAT of a QoS flow, from a network side; determine a BAT of the QoS flow, wherein the BAT of the QoS flow is a time value relative to a boundary of an SFN; and transmit the determined BAT of the QoS flow to the network side.

Some implementations of the methods and apparatuses described herein may further include a method performed by a UE, wherein the method includes: receiving, a request of BAT of a QoS flow, from a network side; determining a BAT of the QoS flow, wherein the BAT of the QoS flow is a time value relative to a boundary of an SFN; and transmitting the determined BAT of the QoS flow to the network side.

Some implementations of the methods and apparatuses described herein may further include a RAN node for wireless communication, wherein the RAN node includes: at least one memory; and at least one processor coupled with the at least one memory and configured to cause the RAN node to: receive a first BAT of a QoS flow used in a first RAN node; and determine a second BAT of the QoS flow used in a second RAN node according to the first BAT and SFN time difference between the first RAN node and the second RAN node, wherein, each BAT of the QoS flow is a time value relative to a boundary of an SFN, and the RAN node is the first RAN node or the second RAN node.

In some implementations of the methods and apparatuses described herein, the at least one processor is configured to cause the UE to: the boundary of an SFN is a boundary of a reference SFN, or a boundary of an SFN in which the BAT is transmitted.

In some implementations of the methods and apparatuses described herein, the RAN node is the second node, and the processor is configured to cause the RAN node to: receive the first BAT of the QoS flow from the first RAN node; and receive an SFN offset of the first RAN node from the first RAN node, wherein the SFN time difference between the first RAN node and the second RAN node is a difference between the SFN offset of the first RAN node and an SFN offset of the second RAN node.

In some cases of the methods and apparatuses described herein, in the case that the first BAT of the QoS flow is a time value relative to the boundary of the reference SFN, the processor is configured to cause the RAN node to: receive the reference SFN for calculating the first BAT of the QoS flow from the first RAN node; and determine the second BAT of the QoS flow according to the first BAT, the SFN time difference between the first RAN node and the second RAN node and the reference SFN for calculating the first BAT.

In some cases of the methods and apparatuses described herein, in the case that the first BAT of the QoS flow is a time value relative to the boundary of the SFN in which the BAT is transmitted, the processor is configured to cause the RAN node to: receive the SFN in which the BAT is transmitted for calculating the first BAT of the QoS flow from the first RAN node; and determine the second BAT of the QoS flow according to the first BAT, the SFN time difference between the first RAN node and the second RAN node and the SFN in which the BAT is transmitted for calculating the first BAT.

In some implementations of the methods and apparatuses described herein, the first RAN node is a source RAN node or MN, and the second RAN node is a target RAN node or SN.

In some cases of the methods and apparatuses described herein, in the case that the first RAN node is a source RAN node and the second RAN node is a target RAN node, the first BAT of the QoS flow is received in a handover request message; or in the case that the first RAN node is an MN and the second RAN node is an SN, the first BAT of the QoS flow is received in an S-NG-RAN node addition request message or an S-NG-RAN node modification request message.

In some implementations of the methods and apparatuses described herein, the RAN node is the first node, and the processor is configured to cause the RAN node to: receive the first BAT of the QoS flow from a UE; and receive an SFN offset of the second RAN node from the second RAN node, wherein the SFN time difference between the first RAN node and the second RAN node is a difference between an SFN offset of the first RAN node and the SFN offset of the second RAN node.

In some cases of the methods and apparatuses described herein, in the case that the second BAT of the QoS flow is a time value relative to the boundary of the reference SFN, the processor is configured to cause the RAN node to: receive the reference SFN for calculating the second BAT of the QoS flow from the second RAN node; and determine the second BAT of the QoS flow according to the first BAT, the SFN time difference between the first RAN node and the second RAN node and the reference SFN for calculating the second BAT.

In some cases of the methods and apparatuses described herein, the first RAN node is a source RAN node or MN, and the second RAN node is a target RAN node or SN.

In some cases of the methods and apparatuses described herein, the processor is configured to cause the RAN node to: transmit the second BAT of the QoS flow to the second RAN node in a handover request message in the case that the first RAN node is a source RAN node and the second RAN node is a target RAN node; or transmit the second BAT of the QoS flow to the second RAN node in an S-NG-RAN node addition request message or an S-NG-RAN node modification request message in the case that the first RAN node is an MN and the second RAN node is an SN.

In some implementations of the methods and apparatuses described herein, the reference SFN and the boundary of the reference SFN are configured or is default, and/or the boundary of the SFN in which the BAT is transmitted is a starting point of a starting subframe of the SFN.

### BRIEF DESCRIPTION OF THE DRAWINGS

FIG. 1 illustrates an example of a wireless communication system in accordance with aspects of the present disclosure.

FIG. 2 illustrates an example of another wireless communication system in accordance with aspects of the present disclosure.

FIG. 3 illustrates some exemplary BATs in accordance with aspects of the present disclosure.

FIG. 4 is a flow chart illustrating a method of supporting BAT reporting in accordance with aspects of the present disclosure.

FIG. 5 is a flow chart illustrating another method of supporting BAT reporting in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrate a flowchart of a method performed by a UE in accordance with aspects of the present disclosure.

FIG. 10 illustrate a flowchart of a method performed by a NE in accordance with aspects of the present disclosure.

### DETAILED DESCRIPTION

Extended reality (XR), including augmented reality (AR) and virtual reality (VR), as well as cloud gaming (CG), presents a new promising category of connected devices, applications, and services. XR traffic characteristics awareness (or XR traffic awareness) in RAN will help gNB's scheduling and radio resource optimization. For uplink (UL) XR traffic awareness, RAN2#122 meeting has agreed that the UE shall report the BAT and UL jitter per QoS flow to the network side, e.g., to a gNB. In accordance with some implementations of the present disclosure, for the BAT, the UE may report a relative time, e.g., a time relative to an SFN boundary to the network side. However, there may be misunderstanding of BAT due to time desynchronization between cells, e.g., between source cell and target cell in the case of handover or between PSCell and PCell in the case of NR-DC.

For example, in the case of handover, the UE calculates the BAT according to the timing (or time) in the source cell and reports the BAT to the source gNB before handover. The source gNB forwards the reported BAT to the target gNB. However, the reported BAT cannot be used by the target gNB directly if the target cell is not time synchronized with the source cell.

In the case of NR-dual connectivity (DC), the MCG and SCG may not be time synchronized. For example, PCell and PSCell are time desynchronized. The UE may calculate the BAT according to the timing of PCell in MCG and report it to the network. Since the PSCell in the SN is not time synchronized with PCell in the MN, the reported BAT cannot be used by the SN directly.

At least to solve the above technical problem, implementations of the present disclosure provide a technical solution of supporting BAT reporting, e.g., a method and apparatus of supporting BAT reporting.

For example, in accordance with some implementations of the present disclosure, the UE calculates (or determines or the like) the BAT of a QoS flow in the source cell and reports it to the source RAN node, e.g., source gNB. The source gNB transmits the BAT used in the source cell, SFN offset in the source cell and optionally a reference SFN (a configured or default SFN) in the source cell to the target RAN node, e.g., the target gNB in a handover request message or the like. The target gNB calculates the BAT used in the target cell according to the received BAT used in the source cell, the SFN time difference (or SFN timing difference, or SFN offset difference or the like) between the source cell and target cell (which can be determined by the SFN offset in the source cell and the SFN offset in the target cell), and the optional reference SFN of the source cell.

In accordance with some other implementations of the present disclosure, the UE calculates the BAT of a QoS flow in the source cell and reports it to the source gNB. The source gNB calculates the BAT used in the target gNB according to the SFN time difference between the source cell and target cell, and sends the calculated BAT used in target gNB to the target gNB.

In accordance with some yet other implementations of the present disclosure, UE will be responsible for determining (or calculating or the like) the BAT for corresponding node(s) in the case of NR-DC. For example, in accordance with some implementations of the present disclosure, the UE calculates the BAT using the SFN time of PCell or PSCell according to the DRB bearer type that the QoS flow belongs to. In accordance with some other implementations of the present disclosure, the UE calculates the BAT using the SFN time of the cell indicated by the network side. In accordance with some yet other implementations of the present disclosure, the UE calculates the BAT using the SFN time of the cell of which radio resource control (RRC) configuration is configured.

The present disclosure solves the technical problem of supporting BAT reporting, avoiding BAT misunderstanding between cells, especially in the cases of handover and NR-DC. Accordingly, the present disclosure will support XR traffic awareness in RAN, and will help scheduling and radio resource optimization in the network side.

Aspects of the present disclosure are described in the context of a wireless communication system.

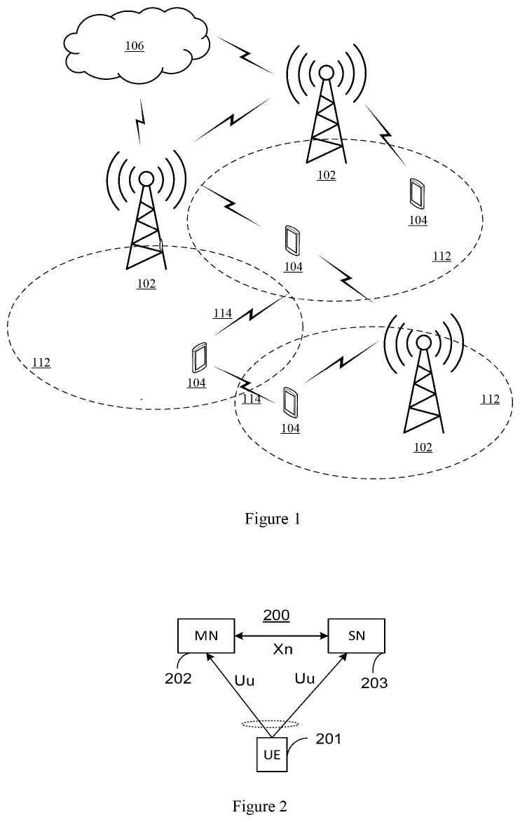

FIG. 1 illustrates an example of a wireless communication system 100 in accordance with aspects of the present disclosure. The wireless communication system 100 may include one or more NE 102, one or more UE 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultrawideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NE 102 may be dispersed throughout a geographic region to form the wireless communication system 100. One or more of the NE 102 described herein may be or include or may be referred to as a network node, a base station, a network element, a network function, a network entity, a RAN, a RAN node, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas 112 may be associated with different NE 102.

The one or more UE 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communication system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. By way of example, the wireless communication system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as an MN and the other node may act as an SN. The MN and SN are connected via a network interface, e.g., Xn interface as specified in 3GPP standard documents, and at least the MN is connected to the CN.

For example, FIG. 2 illustrates an example of another wireless communication system in accordance with aspects of the present disclosure.

As shown in FIG. 2, the wireless communication system 200 may be a dual connectivity system 200 includes at least one UE 201, at least one MN 202, and at least one SN 203. In particular, the dual connectivity system 200 in FIG. 2 includes one shown UE 201, one shown MN 202, and one shown SN 203 for illustrative purpose. Although a specific number of UEs 201, MNs 202, and SNs 203 are depicted in FIG. 2, it is contemplated that any number of UEs 201, MNs 202, and SNs 203 may be included in the wireless communication system 200.

Referring to FIG. 2, the UE 201 may connect to the MN 202 and the SN 203 via an interface, for example, Uu interface as specified in 3GPP standard documents. The MN 202 and the SN 203 may be connected with each other via a network interface, for example, Xn interface as specified in 3GPP standard documents. The MN 202 may be connected to the core network via a network interface (not shown in FIG. 2), for example, NG interface as specified in 3GPP standard documents. The UE 201 may be configured to utilize resources provided by the MN 202 and the SN 203 to perform data transmission.

The MN 202 refers to a RAN node that provides a control plane connection to the core network. In some implementations of the present disclosure, in the E-UTRA-NR DC (EN-DC) scenario, the MN 202 may be an eNB. In some other implementations of the present disclosure, in the next generation E-UTRA-NR DC (NGEN-DC) scenario, the MN 202 may be a next generation (ng)-eNB. In some yet other implementations of the present disclosure, in the NR-DC scenario or the NR-E-UTRA DC (NE-DC) scenario, the MN 202 may be a gNB. An MN 202 may also be referred to as a master-NG-RAN (M-NG-RAN) node in some implementations of the present disclosure.

An MCG may refer to a group of serving cells associated with the MN 202, and include a PCell and optionally one or more secondary cells (SCells). The PCell may provide a control plane connection to the UE 201.

The SN 203 may refer to a radio access network node without control plane connection to the core network but providing additional resources to the UE 201. In some implementations of the present disclosure, in the EN-DC scenario, the SN 203 may be an en-gNB. In some other implementations of the present disclosure, in the NR-DC scenario, the SN 203 may be an ng-eNB. In yet another implementation of the present disclosure, in the NR-DC scenario or the NGEN-DC scenario, the SN 203 may be a gNB. An SN 203 may also be referred to as a secondary-NG-RAN (S-NG-RAN) node in some implementations of the present disclosure.

An SCG may refer to a group of serving cells associated with the SN, and include a PSCell and optionally one or more SCells. The PCell of the MCG and the PSCell of the SCG may also be referred to as an SpCell.

Pursuant to the agreement of RAN2#122, the UE shall report the BAT per QoS flow to the network side, which can at least support XR traffic awareness in the network side. In some implementations of the present disclosure, the BAT can be an absolute time (or an absolute time value) or a relative time (or a relative time value), e.g., a time relative to a boundary of an SFN. The SFN may be a reference SFN, which is a configured or default SFN, or may be an SFN in which the BAT is transmitted. The boundary of the SFN is configured or is specified by default.

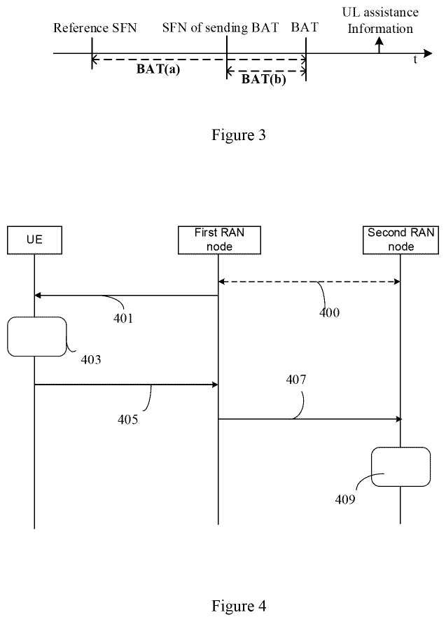

FIG. 3 illustrates some exemplary BATs in accordance with aspects of the present disclosure.

As shown in FIG. 3, in accordance with some implementations of the present disclosure, the BAT of a QoS flow may be represented by a time relative to a boundary of a reference SFN, e.g., BAT(a) shown in FIG. 3. For example, both the reference SFN and its boundary are default, e.g., the boundary of the reference SFN being a starting point of SFN 0 and subframe 0. For another example, the reference SFN is configured to be SFN 512, the boundary of the SFN is a starting point of a starting subframe of the SFN by default, and thus the boundary of the reference SFN is a starting point of the SFN 512 and subframe 0.

In accordance with some implementations of the present disclosure, the BAT of a QoS flow may be represented by a time relative to a boundary of an SFN in which the BAT is transmitted (or will be transmitted), e.g., BAT(b) shown in FIG. 3. For example, the boundary of the SFN is configured to be or specified by default to be a starting point of a starting subframe of the SFN in which the BAT is transmitted, e.g., the starting point of subframe 0 of the SFN in which the BAT is transmitted. An SFN in which the BAT is transmitted may also be referred to as an SFN of sending (or transmitting) BAT. Considering that UE may report the BAT to the source gNB in a UE assistance information message, an exemplary SFN of sending BAT may be an SFN of sending UE assistance information.

However, the same boundary of an SFN may correspond to different time in difference cells (or RAN nodes), that is, there may be time desynchronization between cells. Thus, in the case that the BAT is a relative time, there may be BAT misunderstanding issues due to the time desynchronization between cells, which needs to be obviated. Herein, some implementations of the present disclosure will be specifically illustrated in view of a BAT as a time relative to an SFN boundary. In addition, although the BAT is illustrated as a BAT of a QoS flow, persons skilled in the art should well know that technical solution disclosed and taught herein can also be applied to the BAT expressed in other manners (e.g. the BAT is illustrated as a BAT of a DRB).

FIG. 4 is a flow chart illustrating a method of supporting BAT reporting in accordance with aspects of the present disclosure. Although the method is illustrated in a system level among a UE, a first RAN node and a second RAN node, persons skilled in the art should understand that the method implemented in the UE and the two RAN nodes can be separately implemented and/or incorporated by other apparatus with the like functions.

In different scenarios, the first RAN node and second RAN node may act different roles. For example, in some scenarios, e.g., in the scenarios of handover, the first RAN node is a source RAN node, e.g., a source gNB and the second RAN node is a target RAN node, e.g., a target gNB. In some other scenarios, e.g., in the scenarios of NR-DC, the first RAN node is an MN and the second RAN node is an SN.

Taking the scenarios of handover as an example, as shown in FIG. 4, in step 401, the UE will receive, a request of BAT of a QoS flow, from the first RAN node, e.g., the source RAN node. The UE will determine (or calculate or the like) the BAT of the QoS flow used in the source RAN node (or source cell) in step 403. The BAT of the QoS flow used in the first RAN node, e.g., the source RAN node (or source cell) may also be referred to as a first BAT of the QoS flow for simplification. As stated above, since a BAT of a QoS can be represented in various manners, there are various manners of determining the BAT of the QoS flow. For example, the BAT of the QoS used in the source RAN node can be determined as a time relative to the boundary of a reference SFN, or can be determined as a time relative to the boundary of the SFN in which the BAT is transmitted.

The UE will report the determined BAT of the QoS flow used in the source cell, i.e., the first BAT to the source RAN node in step 405, e.g., in a UE assistance information message.

After receiving the first BAT from the UE, the source RAN node will transmit the first BAT to the target RAN node in step 407, e.g., in a handover request message. For example, the first BAT may be included in an inter-node RRC message as an RRC container or in an explicit information element (IE) of an Xn-AP message. In the case that the first BAT is a time relative to the boundary of a reference SFN, the source RAN node may also send the reference SFN for determining the first BAT to the target RAN node, e.g., in the handover request message or another message. However, in the case that the reference SFN is specified as a fixed value (default), the reference SFN is not needed to be transmitted to the target RAN node. In the case that the first BAT is a time relative to the boundary of the SFN in which the BAT is transmitted, the SFN in which the BAT is transmitted will also be provided to the target RAN node, e.g., in the handover request message.

The source RAN node may also transmit the SFN offset of the source RAN node (or source cell) to the target RAN node (or target cell), so that the SFN time difference in the source RAN node and target node will be determined in the target RAN node. Regarding an SFN offset, it contains the time offset between an absolute time reference and that a starting SFN starts, e.g., SFN 0 starts. The SFN offset is calculated assuming that the SFN transmission started at the absolute time reference. An exemplary absolute time reference is 1980-01-06 T00:00:19 international atomic time (TAI). In some cases, the source RAN node and the target RAN node may transmit respective SFN offset to each other in step 400 as legacy, e.g., in an Xn setup request message or NG-RAN node configuration update message. In some other cases, the source RAN node may transmit the SFN offset of the source RAN node in another step or transmit the SFN time difference between the source and target cells directly from the source RAN node in the handover request message or the like.

In step 409, the target RAN node will determine the BAT of the QoS flow used in the target RAN node (or target cell) according to the first BAT and SFN time difference between the source RAN node and the target RAN node. The SFN time difference between the source RAN node and the target RAN node may be a difference between the SFN offset of the first RAN node and an SFN offset of the second RAN node.

The BAT of the QoS flow used in the second RAN node, e.g., the target RAN node (or target cell) may also be referred to as the second BAT of the QoS flow for simplification. In the case that the BAT used in the source cell, i.e., the first BAT is a time relative to the boundary of a reference SFN, the target RAN node will determine the second BAT as a time relative to the boundary of the reference SFN according to the first BAT, the SFN time difference between the source RAN node and the target RAN node, and the reference SFN of the source cell. For example, the BAT used in target cell, i.e., the second BAT may be determined by (SFN offset of the target cell-SFN offset of the source cell+the BAT used in the source cell) assuming that the reference SFN of the source cell is SFN 0. In the case that the BAT used in the source cell, i.e., the first BAT is a time relative to the boundary of an SFN of transmitting the first BAT, the target RAN node will determine the second BAT as a time relative to the boundary of the SFN of transmitting the first BAT according to the first BAT, the SFN time difference between the source RAN node and the target RAN node, and the SFN of transmitting the first BAT.

The identical or similar technical solution as that illustrated in view of the scenarios of handover in FIG. 4 can also be applied in the scenarios of NR-DC, wherein the first RAN node is an MN and the second RAN node is an SN. That is, the source RAN node illustrated above will be replaced by an MN, e.g., a master NG-RAN node and the target RAN node will be replaced by an SN, e.g., a secondary NG-RAN node. Information related to BAT determination or reporting may also be transmitted in adaptive messages between in the MN and SN. For example, the handover request message where the first BAT (the BAT used in the first RAN node) will be transmitted is replaced by an S-NG-RAN node addition request message or an S-NG-RAN node modification request message or the like.

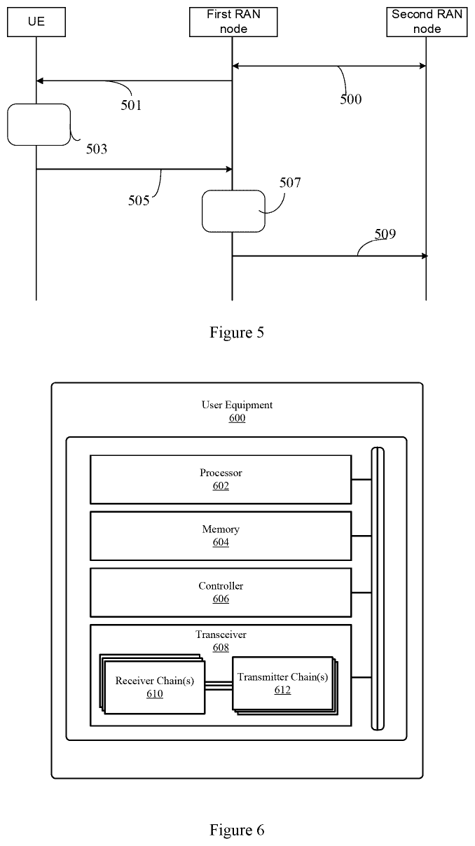

FIG. 5 is a flow chart illustrating another method of supporting BAT reporting in accordance with aspects of the present disclosure. Although the method is illustrated in a system level among a UE, a first RAN node and a second RAN node, persons skilled in the art should understand that the method implemented in the UE and the two RAN nodes can be separately implemented and/or incorporated by other apparatus with the like functions.

Similarly, in different scenarios, the first RAN node and second RAN node may act different roles. For example, in some scenarios, e.g., in the scenarios of handover, the first RAN node is a source RAN node, e.g., a source gNB and the second RAN node is a target RAN node, e.g., a target gNB. In some other scenarios, e.g., in the scenarios of NR-DC, the first RAN node is an MN, e.g., a master NG-RAN node and the second RAN node is an SN, e.g., a secondary NG-RAN node.

Still taking the scenarios of handover as an example, as shown in FIG. 5, in step 501, the UE will receive, a request of BAT of a QoS flow, from the source RAN node. The UE will determine (or calculate or the like) the BAT of the QoS flow used in the source RAN node (or source cell), i.e., a first BAT of the QoS flow in step 503. Similarly, since a BAT of a QoS can be represented in various manners, there are various manners of determining the BAT of the QoS flow. For example, the BAT of the QoS used in the source RAN node, i.e., the first BAT may be determined as a time relative to the boundary of a reference SFN, or can be determined as a time relative to the boundary of the SFN in which the BAT is transmitted.

The UE will report the determined BAT of the QoS flow used in the source cell, i.e., the first BAT to the source RAN node in step 505, e.g., in a UE assistance information message.

In step 507, the source RAN node will determine a BAT of the QoS flow used in the second RAN node, i.e., the second BAT of the QoS flow according to the first BAT and SFN time difference between the first RAN node and the second RAN node. In some cases, the SFN time difference between the first RAN node and the second RAN node may be a difference between the SFN offset of the first RAN node and an SFN offset of the second RAN node. Before that, the source RAN node may also receive the SFN offset of the target RAN node (or target cell) from the target RAN node (or target cell). In some cases, the source RAN node and the target RAN node may transmit respective SFN offset to each other in step 500 as legacy, e.g., in an Xn setup request message or NG-RAN node configuration update message. The target RAN node may optionally transmit a reference SFN with the SFN offset to the source cell to the in step 500 in some cases. In some other cases, the source RAN node may receive the SFN offset of the target RAN node in another step.

In the case that the BAT used in the source cell, i.e., the first BAT is a time relative to the boundary of a reference SFN, the source RAN node will determine the second BAT as a time relative to the boundary of the reference SFN according to the first BAT, the SFN time difference between the source RAN node and the target RAN node, and the reference SFN of the source cell. For example, the BAT used in target cell, i.e., the second BAT may be determined by (SFN offset of the target cell−SFN offset of the source cell+the BAT used in the source cell) assuming that the reference SFN is SFN 0. In the case that the BAT used in the source cell, i.e., the first BAT is a time relative to the boundary of an SFN of transmitting the first BAT, the source RAN node will determine the second BAT as a time relative to the boundary of the SFN of transmitting the first BAT according to the first BAT, the SFN time difference between the source RAN node and the target RAN node, and the SFN of transmitting the first BAT.

After determining the second BAT of the QoS flow, the source RAN node will transmit the second BAT to the target RAN node in step 509, e.g., in a handover request message. For example, the second BAT may be included in an inter-node RRC message as an RRC container or in an explicit IE of an Xn-AP message.

Similarly, the identical or similar technical solution as that illustrated in view of the scenarios of handover in FIG. 5 can be applied in the scenarios of NR-DC, wherein the first RAN node is an MN and the second RAN node is an SN. That is, the source RAN node illustrated above will be replaced by an MN, e.g., a master NG-RAN node and the target RAN node will be replaced by an SN, e.g., a secondary NG-RAN node. Information related to BAT determination or reporting may also be transmitted in adaptive messages between in the MN and SN. For example, the handover request message where the second BAT (the BAT used in the second RAN node) will be transmitted can be replaced by an S-NG-RAN node addition request message or an S-NG-RAN node modification request message.

In accordance with aspects of the present disclosure, a technical solution of BAT determination or calculation by the UE, rather than the network side is also provided to support BAT reporting in the scenarios of NR-DC, which can also avoid the BAT misunderstanding due to time desynchronization between MN and SN. The BAT determined by the UE can be a BAT used in the MN, i.e., the first BAT, or can be a BAT used in the SN, i.e., the second BAT, which may be a time relative to a boundary of an SFN as stated above. The UE may perform the BAT determination as requested by the network side, which may be explicitly requested or implicitly requested.

In some implementations of the present disclosure, the UE calculates the BAT using the SFN time of PCell or PSCell according to the DRB bearer type that the QoS flow belongs to. Which cell (e.g., PCell or SCell) or cell group (e.g., MCG or SCG) will be used for the BAT calculation depends on the DRB bearer type. The cell or cell group used for BAT calculation may also be referred to as a reference point. That is, UE autonomously determines the reference point based on DRB type.

In the case that the DRB is MCG bearer or SCG bearer only, the UE will calculate the BAT according to the MCG or SCG, respectively. In other words, in the case that the DRB is served by MCG or SCG only, the UE calculates the BAT according to the SFN time (e.g., SFN offset) of Pcell or PSCell respectively. For example, in some cases, the MN configures that the UE reports the BAT of a QoS flow or a DRB. If the QoS flow or the DRB is served MCG or SCG only (MCG bearer or SCG bearer only), the UE will use the SFN time of the PCell (MCG) or PSCell (SCG) for calculating the BAT respectively.

In the case that the DRB is configured with duplicated or split bearer type, that is, the DRB is served by both MCG and SCG, the UE may calculate both the BAT of PCell (MCG) and BAT of PSCell (SCG) and report them to the network side. For example, in the case that the MN configures that the UE reports the BAT of a QoS flow or a DRB, wherein the UL data transmission of the QoS flow or the DRB is served by both MCG and SCG (UL split bearer), the UE will use the SFN time of the PCell (MCG) for calculating the BAT of PCell (MCG) and will use the SFN of the PSCell (SCG) for calculating the BAT of the PSCell (SCG). The UE reports the BAT of PCell and the BAT of the PSCell to the network side, and explicitly or implicitly indicates which BAT is for PCell (MCG) and which BAT is for PSCell (SCG).

In accordance with some other implementations of the present disclosure, in the case that the DRB is served by UL split bearer, the UE calculates the BAT of the SPCell of the primary path that configured by the network. For example, for a UL split bearer, the network may configure a primary path (e.g., MCG or SCG) for the UL data transmission. If the MCG is configured as the primary path, the UE will use the SFN time of PCell (MCG) for calculating the BAT. If the SCG is configured as the primary path, the UE will use the SFN time of PSCell (SCG) for calculating the BAT.

The network side may change (or update) the bearer type by RRC reconfiguration or the like. In the case that the DRB type changes, the UE will update the BAT according to the updated DRB type and report the updated BAT to the network side correspondingly.

For example, the DRB is configured as an MCG bearer and the UE uses the SFN time of the PCell (MCG) for calculating the BAT initially. Then, the network side reconfigures the DRB to be a SCG bearer. When receiving the bearer type change indication from MCG bearer to SCG bearer, the UE will determine or calculate or update the BAT according to the SFN time of PSCell (SCG), and report the updated BAT to the network side, e.g., to the MN and the MN will forward the updated BAT to the SN.

For another example, the DRB is configured as MCG bearer and the UE uses the SFN time of the PCell (MCG) for calculating the BAT initially. Then, the network side reconfigures the DRB to be a split bearer. When receiving the bearer type change indication from MCG bearer to split bearer, the UE will also determine or calculate the BAT according to the SFN time of PSCell (SCG), and also report the BAT according to the SFN time of PSCell (SCG) to the network side, e.g., report to the MN and the MN will forward the BAT according to the SFN time of PSCell (SCG) to the SN.

For yet another example, the DRB is configured as split bearer and MCG is configured as primary path, and the UE uses the SFN time of the PCell (MCG) for calculating the BAT initially. Then, the network side reconfigures the split DRB's primary path to SCG. When receives the primary path change indication of the split bearer from MCG to SCG, the UE will determine or calculate or update the BAT according to the SFN time of PSCell (SCG), and report the updated BAT to the network side, e.g., to the MN and the MN will forward the updated BAT to the SN.

In some implementations of the present disclosure, the network side will configure to which cell is referred for calculating the BAT, e.g., PCell or SCell, MCG or SCG, or both etc. The UE will calculate the BAT according to the cell indicated by the network side. In the case that the network side configures that the PCell (MCG) is used for calculating BAT, the UE will use the SFN time of the PCell (MCG) for calculating the BAT. In the case that the network side configures the PSCell (SCG) is used for calculating BAT, the UE will use the SFN time of the PSCell (SCG) for calculating the BAT. In the case that the network side configures both PCell (MCG) and PSCell (SCG) are used for calculating BAT, the UE uses the SFN time of PCell (MCG) for calculating the BAT of PCell (MCG) and uses the SFN time of PSCell (SCG) for calculating the BAT of the PSCell (SCG). Accordingly, the UE will report both the two BATs to the network side, and will also explicitly or implicitly indicate which BAT is for MCG and which BAT is for SCG.

In some implementations of the present disclosure, the UE calculates the BAT according to the SFN time of the cell (or node) from which RRC configuration is configured.

For example, in the case that the network side requests BAT reporting in the MCG configuration, e.g. in the masterCellGroup IE, the UE will use the SFN time of the PCell (MCG) for calculating the BAT.

In the case that the network side requests BAT reporting in the SCG configuration, e.g. in the secondaryCellGroup IE, the UE will use the SFN time of the PSCell (SCG) for calculating the BAT.

In the case that the network side requests BAT to be reported by SRB 3 or the BAT is configured by SRB 3, the UE will use the SFN time of the PSCell (SCG) for calculating the BAT and reports to the SN by SRB3 directly.

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, a request of BAT of a QoS flow, from a network side; to support a means for determining a BAT of the QoS flow, wherein the BAT of the QoS flow is a time value relative to a boundary of an SFN; and to support a means for transmitting the determined BAT of the QoS flow to the network side.

In some implementations, the at least one processor is configured to cause the UE to: receive, the request of BAT of the QoS flow, from a source RAN node; determine the BAT of the QoS flow used in the source RAN node; and transmit the determined BAT of the QoS flow to the source RAN node.

In some implementations, the at least one processor is configured to cause the UE to: receive, the request of BAT of the QoS flow, from an MN; determine the BAT of the QoS flow used in the MN; and transmit the determined BAT of the QoS flow to the MN.

In some implementations, the determined BAT of the QoS flow is transmitted to the network side in UE assistance information message.

In some implementations, the at least one processor is configured to cause the UE to: receive, the request of BAT of the QoS flow, from an MN; determine the BAT of the QoS flow according to a type of a DRB that the QoS flow belongs to; and transmit the determined BAT of the QoS flow to the MN.

In some cases, the at least one processor is configured to cause the UE to: receive information indicating an updated type of the DRB that the QoS flow belongs to; and determine the BAT of the QoS flow according to the updated type of the DRB that the QoS flow belongs to.

In some cases, the at least one processor is configured to cause the UE to: determine the BAT of the QoS flow by using SFN time of a PCell in the case that the DRB is served by MCG only; or determine the BAT of the QoS flow by using SFN time of a PSCell in the case that the DRB is served by SCG only; or determine a first BAT of the QoS flow by using the SFN time of the PCell and a second BAT of the QoS flow by using the SFN time of the PSCell in the case that the DRB is served by both the MCG and SCG; or determine the BAT of the QoS flow by using SFN time of an SPCell of a configured primary path in the case that the DRB is served by uplink split bearer.

In some implementations, the at least one processor is configured to cause the UE to: receive, the request of BAT of the QoS flow, from an MN; determine the BAT of the QoS flow according to a cell indicated by the MN for calculating BAT; and transmit the determined BAT of the QoS flow to the MN.

In some cases, the at least one processor is configured to cause the UE to: determine the BAT of the QoS flow by using SFN time of a PCell in the case that only the PCell or MCG is indicated; or determine the BAT of the QoS flow by using SFN time of a PSCell in the case that only the PSCell or SCG is indicated; or determine a first BAT of the QoS flow by using the SFN time of the PCell and a second BAT of the QoS flow by using the SFN time of the PSCell in the case that both PCell and PSCell are indicated or both the MCG and SCG are indicated.

In some cases, the at least one processor is configured to cause the UE to: transmit the first BAT and the second BAT to the MN with information indicating which BAT is for MCG and which BAT is for SCG, in the case that the both the first BAT and second BAT are determined.

In some implementations, the at least one processor is configured to cause the UE to: receive, the request of BAT of the QoS flow in MCG configuration, from an MN; determine the BAT of the QoS flow by using SFN time of a PCell and transmit the determined BAT of the QoS flow to the MN.

In some implementations, the at least one processor is configured to cause the UE to: receive, the request of BAT of the QoS flow in SCG configuration, from an MN; determine the BAT of the QoS flow by using SFN time of a PSCell; and transmit the determined BAT of the QoS flow to the MN.

In some implementations, the at least one processor is configured to cause the UE to: receive, the request of BAT of the QoS flow, from an MN or an SN, wherein the BAT of the QoS flow is configured to be reported by an SRB 3; determine the BAT of the QoS flow by using SFN time of a PSCell of SCG; and transmit the determined BATs of the QoS flow to the SN.

In some implementations, the at least one processor is configured to cause the UE to: receive, the request of BAT of the QoS flow, from an MN or an SN, wherein the BAT of the QoS flow is configured by an SRB 3; determine the BAT of the QoS flow by using SFN time of a PSCell of SCG; and transmit the determined BATs of the QoS flow to the SN by SRB3.

In some implementations, the boundary of an SFN is a boundary of a reference SFN, or a boundary of an SFN in which the BAT is transmitted.

In some implementations, the reference SFN and the boundary of the reference SFN are configured or is default, and/or the boundary of the SFN in which the BAT is transmitted is a starting point of a starting subframe of the SFN.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving, a request of BAT of a QoS flow, from a network side; to support a means for determining a BAT of the QoS flow, wherein the BAT of the QoS flow is a time value relative to a boundary of an SFN; and to support a means for transmitting the determined BAT of the QoS flow to the network side.

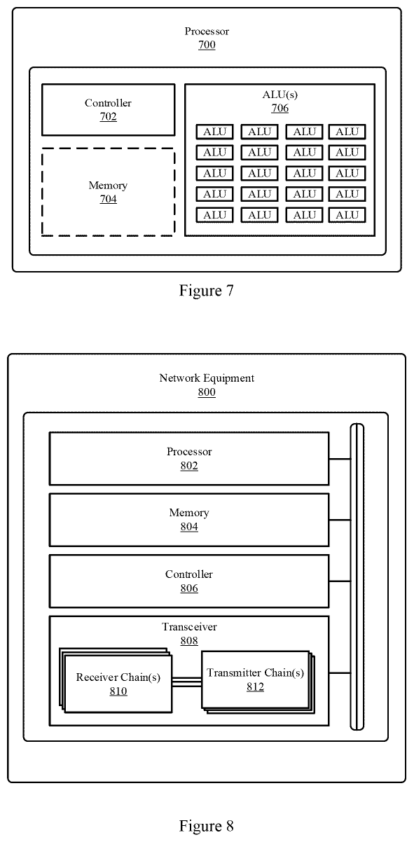

FIG. 8 illustrates an example of a NE 800, e.g., the first RAN node or second RAN node in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving a first BAT of a QoS flow used in a first RAN node; and to support a means for determining a second BAT of the QoS flow used in a second RAN node according to the first BAT and SFN time difference between the first RAN node and the second RAN node, wherein, each BAT of the QoS flow is a time value relative to a boundary of an SFN, and the RAN node is the first RAN node or the second RAN node.

In some implementations, the at least one processor is configured to cause the UE to: the boundary of an SFN is a boundary of a reference SFN, or a boundary of an SFN in which the BAT is transmitted.

In some implementations, the RAN node is the second node, and the processor is configured to cause the RAN node to: receive the first BAT of the QoS flow from the first RAN node; and receive an SFN offset of the first RAN node from the first RAN node, wherein the SFN time difference between the first RAN node and the second RAN node is a difference between the SFN offset of the first RAN node and an SFN offset of the second RAN node.

In some cases, in the case that the first BAT of the QoS flow is a time value relative to the boundary of the reference SFN, the processor is configured to cause the RAN node to: receive the reference SFN for calculating the first BAT of the QoS flow from the first RAN node; and determine the second BAT of the QoS flow according to the first BAT, the SFN time difference between the first RAN node and the second RAN node and the reference SFN for calculating the first BAT.

In some cases, in the case that the first BAT of the QoS flow is a time value relative to the boundary of the SFN in which the BAT is transmitted, the processor is configured to cause the RAN node to: receive the SFN in which the BAT is transmitted for calculating the first BAT of the QoS flow from the first RAN node; and determine the second BAT of the QoS flow according to the first BAT, the SFN time difference between the first RAN node and the second RAN node and the SFN in which the BAT is transmitted for calculating the first BAT.

In some implementations, the first RAN node is a source RAN node or MN, and the second RAN node is a target RAN node or SN.

In some cases, in the case that the first RAN node is a source RAN node and the second RAN node is a target RAN node, the first BAT of the QoS flow is received in a handover request message; or in the case that the first RAN node is an MN and the second RAN node is an SN, the first BAT of the QoS flow is received in an S-NG-RAN node addition request message or an S-NG-RAN node modification request message.

In some implementations, the RAN node is the first node, and the processor is configured to cause the RAN node to: receive the first BAT of the QoS flow from a UE; and receive an SFN offset of the second RAN node from the second RAN node, wherein the SFN time difference between the first RAN node and the second RAN node is a difference between an SFN offset of the first RAN node and the SFN offset of the second RAN node.

In some cases, in the case that the second BAT of the QoS flow is a time value relative to the boundary of the reference SFN, the processor is configured to cause the RAN node to: receive the reference SFN for calculating the second BAT of the QoS flow from the second RAN node; and determine the second BAT of the QoS flow according to the first BAT, the SFN time difference between the first RAN node and the second RAN node and the reference SFN for calculating the second BAT.

In some cases, the first RAN node is a source RAN node or MN, and the second RAN node is a target RAN node or SN.

In some cases, the processor is configured to cause the RAN node to: transmit the second BAT of the QoS flow to the second RAN node in a handover request message in the case that the first RAN node is a source RAN node and the second RAN node is a target RAN node; or transmit the second BAT of the QoS flow to the second RAN node in an S-NG-RAN node addition request message or an S-NG-RAN node modification request message in the case that the first RAN node is an MN and the second RAN node is an SN.

In some implementations, the reference SFN and the boundary of the reference SFN are configured or is default, and/or the boundary of the SFN in which the BAT is transmitted is a starting point of a starting subframe of the SFN.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

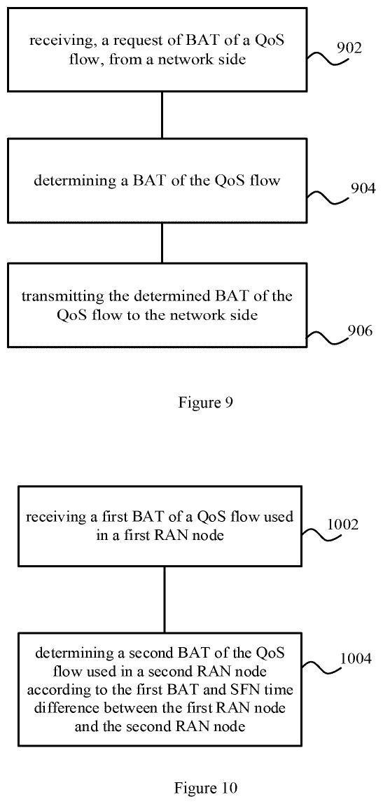

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At step 902, the method may include receiving, a request of BAT of a QoS flow, from a network side. The operations of step 902 may be performed in accordance with examples as described herein. In some implementations, aspects of the operations of 902 may be performed by a UE as described with reference to FIG. 6.

At step 904, the method may include determining a BAT of the QoS flow, wherein the BAT of the QoS flow is a time value relative to a boundary of an SFN. The operations of step 904 may be performed in accordance with examples as described herein. In some implementations, aspects of the operations of step 904 may be performed by a UE as described with reference to FIG. 6.

At step 906, the method may include transmitting the determined BAT of the QoS flow to the network side. The operations of step 906 may be performed in accordance with examples as described herein. In some implementations, aspects of the operations of step 906 may be performed a UE as described with reference to FIG. 6.

It should be noted that the method described herein describes a possible implementation, and that the operations and the steps may be rearranged or otherwise modified and that other implementations are possible.

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At step 1002, the method may include receiving a first BAT of a QoS flow used in a first RAN node. The operations of step 1002 may be performed in accordance with examples as described herein. In some implementations, aspects of the operations of step 1002 may be performed by a NE as described with reference to FIG. 8.

At step 1004, the method may include determining a second BAT of the QoS flow used in a second RAN node according to the first BAT and SFN time difference between the first RAN node and the second RAN node, wherein, each BAT of the QoS flow is a time value relative to a boundary of an SFN, and the RAN node is the first RAN node or the second RAN node. The operations of step 1004 may be performed in accordance with examples as described herein. In some implementations, aspects of the operations of step 1004 may be performed a NE as described with reference to FIG. 8.

It should be noted that the method described herein describes possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a request of a burst arrival time (BAT) of a quality of service (QoS) flow from a network side;
determine a BAT of the QoS flow, wherein the BAT of the QoS flow is a time value relative to a boundary of a system frame number (SFN); and
transmit the determined BAT of the QoS flow to the network side.

2. The UE of claim 1, wherein the at least one processor is configured to cause the UE to:
receive the request of the BAT of the QoS flow from a source radio access network (RAN) node;
determine the BAT of the QoS flow used in the source RAN node; and
transmit the determined BAT of the QoS flow to the source RAN node.

3. The UE of claim 1, wherein the at least one processor is configured to cause the UE to:
receive the request of the BAT of the QoS flow from a master node (MN);
determine the BAT of the QoS flow used in the MN; and
transmit the determined BAT of the QoS flow to the MN.

4. The UE of claim 1, wherein the at least one processor is configured to cause the UE to:
receive the request of the BAT of the QoS flow from a master node (MN);
determine the BAT of the QoS flow according to a type of a data radio bearer (DRB) to which the QoS flow belongs; and
transmit the determined BAT of the QoS flow to the MN.

5. The UE of claim 4, wherein the at least one processor is configured to cause the UE to:
determine the BAT of the QoS flow by using an SFN time of a primary cell (PCell) when the DRB is only served by master cell group (MCG);
determine the BAT of the QoS flow by using an SFN time of a primary secondary cell (PSCell) when the DRB is only served by secondary cell group (SCG);
determine a first BAT of the QoS flow by using the SFN time of the PCell and a second BAT of the QoS flow by using the SFN time of the PSCell when the DRB is served by both the MCG and the SCG; or
determine the BAT of the QoS flow by using an SFN time of a special cell (SPCell) of a configured primary path when the DRB is served by an uplink split bearer.

6. The UE of claim 1, wherein the at least one processor is configured to cause the UE to:
receive the request of the BAT of the QoS flow from a master node (MN);
determine the BAT of the QoS flow according to a cell indicated by the MN for calculating the BAT; and
transmit the determined BAT of the QoS flow to the MN.

7. The UE of claim 6, wherein the at least one processor is configured to cause the UE to:
determine the BAT of the QoS flow by using an SFN time of a primary cell (PCell) when only the PCell or a master cell group (MCG) is indicated;
determine the BAT of the QoS flow by using an SFN time of a primary secondary cell (PSCell) when only the PSCell or a secondary cell group (SCG) is indicated; or
determine a first BAT of the QoS flow by using the SFN time of the PCell and a second BAT of the QoS flow by using the SFN time of the PSCell when both the PCell and the PSCell are indicated or both the MCG and the SCG are indicated.

8. The UE of claim 1, wherein the at least one processor is configured to cause the UE to:
receive the request of the BAT of the QoS flow in master cell group (MCG) configuration from a master node (MN);
determine the BAT of the QoS flow by using an SFN time of a primary cell (PCell); and
transmit the determined BAT of the QoS flow to the MN.

9. The UE of claim 1, wherein the at least one processor is configured to cause the UE to:
receive the request of the BAT of the QoS flow in a secondary cell group (SCG) configuration from a master node (MN);
determine the BAT of the QoS flow by using an SFN time of a primary secondary cell (PSCell); and
transmit the determined BAT of the QoS flow to the MN.

10. The UE of claim 1, wherein the at least one processor is configured to cause the UE to:
receive the request of the BAT of the QoS flow from a master node (MN) or a secondary node (SN), wherein the BAT of the QoS flow is configured to be reported by a signaling radio bearer (SRB) 3;
determine the BAT of the QoS flow by using an SFN time of a primary secondary cell (PSCell) of a secondary cell group (SCG); and
transmit the determined BAT of the QoS flow to the SN.

11. The UE of claim 1, wherein the at least one processor is configured to cause the UE to:
receive the request of the BAT of the QoS flow from a master node (MN) or a secondary node (SN), wherein the BAT of the QoS flow is configured by signaling radio bearer (SRB) 3;
determine the BAT of the QoS flow by using an SFN time of a primary secondary cell (PSCell) of a secondary cell group (SCG); and
transmit the determined BAT of the QoS flow to the SN by the SRB3.

12. The UE of claim 1, wherein the boundary of the SFN is a boundary of a reference SFN, or a boundary of an SFN in which the BAT is transmitted.

13. A processor for wireless communication, comprising:
at least one controller coupled with at least one memory and configured to cause the processor to:
receive a request of a burst arrival time (BAT) of a quality of service (QoS) flow from a network side;
determine a BAT of the QoS flow, wherein the BAT of the QoS flow is a time value relative to a boundary of a system frame number (SFN); and
transmit the determined BAT of the QoS flow to the network side.

14. A radio access network (RAN) node for wireless communication, comprising:
at least one memory; and
at least one processor coupled with the at least one memory and configured to cause the RAN node to:
receive a first burst arrival time (BAT) of a quality of service (QoS) flow used in a first RAN node; and
determine a second BAT of the QoS flow used in a second RAN node according to the first BAT and a system frame number (SFN) time difference between the first RAN node and the second RAN node,
wherein each BAT of the QoS flow is a time value relative to a boundary of an SFN, and wherein the RAN node is the first RAN node or the second RAN node.

15. The RAN node of claim 14, wherein the boundary of an SFN is a boundary of a reference SFN, or a boundary of an SFN in which the BAT is transmitted.

16. The RAN node of claim 15, wherein the RAN node is the second node, and wherein the at least one processor is configured to cause the RAN node to:
receive the first BAT of the QoS flow from the first RAN node; and
receive an SFN offset of the first RAN node from the first RAN node, wherein the SFN time difference between the first RAN node and the second RAN node is a difference between the SFN offset of the first RAN node and an SFN offset of the second RAN node.

17. The RAN node of claim 16, wherein, when the first BAT of the QoS flow is a time value relative to the boundary of the reference SFN, the at least one processor is configured to cause the RAN node to:
receive the reference SFN for calculating the first BAT of the QoS flow from the first RAN node; and
determine the second BAT of the QoS flow according to the first BAT, the SFN time difference between the first RAN node and the second RAN node and the reference SFN for calculating the first BAT.

18. The RAN node of claim 15, wherein the RAN node is the first node, and wherein the at least one processor is configured to cause the RAN node to:
receive the first BAT of the QoS flow from a user equipment (UE); and
receive an SFN offset of the second RAN node from the second RAN node, wherein the SFN time difference between the first RAN node and the second RAN node is a difference between an SFN offset of the first RAN node and the SFN offset of the second RAN node.

19. The RAN node of claim 18, wherein, when the second BAT of the QoS flow is a time value relative to the boundary of the reference SFN, the at least one processor is configured to cause the RAN node to:
receive the reference SFN for calculating the second BAT of the QoS flow from the second RAN node; and
determine the second BAT of the QoS flow according to the first BAT, the SFN time difference between the first RAN node and the second RAN node and the reference SFN for calculating the second BAT.

20. A method performed by a user equipment (UE), the method comprising:
receiving a request of a burst arrival time (BAT) of a quality of service (QoS) flow from a network side;
determining a BAT of the QoS flow, wherein the BAT of the QoS flow is a time value relative to a boundary of a system frame number (SFN); and
transmitting the determined BAT of the QoS flow to the network side.
